(19) United States
(12) Patent Application Publication
(10) Pub. No.: US 2016/0312864 A1
(43) Pub. Date: Oct. 27, 2016

(54) HOLLOW TRACK BODY AND ACTUATOR

(71) Applicant: THK CO., LTD., Tokyo (JP)

(72) Inventors: Hiroyuki Kishi, Tokyo (JP); Noritaka Suzuki, Tokyo (JP); Eriko Watanabe, Tokyo (JP)

(73) Assignee: THK CO., LTD., Tokyo (JP)

(21) Appl. No.: 15/105,058

(22) PCT Filed: Dec. 4, 2014
(86) PCT No.: PCT/JP2014/082123

§ 371 Date: Jun. 16, 2016

(30) Foreign Application Priority Data
Dec. 24, 2013 (JP) 2013-265654

(51) Int. Cl. F16H 19/04; F16C 29/06; F16H 55/26

(52) U.S. Cl. CPC F16H 19/04; F16H 55/26; F16C 29/06

(57) ABSTRACT

A hollow track body (21) has a plurality of rolling body traveling sections (22) formed in an outer surface of a hollow shaft in an axial direction and is supported by a support body (31) via a plurality of rolling bodies (40) that are rollable along the plurality of rolling body traveling sections (22), wherein a rack teeth array (25) in which roots of teeth penetrate into a hollow section (21h) of the hollow shaft are formed at arc-shaped sections (21a, 21b) formed between the plurality of rolling body traveling sections (22) in the axial direction.

### TECHNICAL FIELD

The present invention relates to a hollow track body and an actuator.

Priority is claimed on Japanese Patent Application No. 2013-265654, filed on Dec. 24, 2013, the content of which is incorporated herein by reference.

### BACKGROUND ART

A movement guide apparatus such as a linear guide or the like includes a track body, a support body and a rolling body.

A circulation path is formed between the track body and the support body. As the rolling body circulates (rolls) through the circulation path, the track body and the support body move relative thereto.

In order to reduce the weight of the track body, a movement guide apparatus having a through-hole (a hollow section) extending in an axial direction thereof is installed at a track rail (Patent Literature 1).

Reduction in weight of the track body is effective when the movement guide apparatus is incorporated with a rod-type actuator or the like. The moment of inertia is reduced by the reduction in weight of the track body, and the moving speed or responsiveness of the track body is improved. Accordingly, productivity of a production facility using the actuator can be improved.

### CITATION LIST

### Patent Literature

[Patent Literature 1]

Japanese Unexamined Patent Application, First Publication No. 2010-144897

### SUMMARY OF INVENTION

### Technical Problem

When the movement guide apparatus is incorporated with the actuator, as a rack teeth array is formed at the track body and a pinion gear is meshed therewith, the track body can be driven by a rotary motor.

Since a plurality of rolling body traveling surfaces on which a rolling body rolls are formed in an outer surface of the track body, teeth of the rack teeth array may not be largely set. In particular, like Patent Literature 1, when the track body has a rectangular cross-sectional shape, the rack teeth array may not be formed at an upper surface of the track body (a surface 54 of a slide side in Patent Literature 1).

When the rack teeth array formed at the outer surface of the track body have small teeth, a large driving force cannot be transmitted to the track body. In addition, the durability of the rack teeth array is decreased, and the product lifetime of the actuator is reduced.

The present invention provides a hollow track body capable of forming a rack teeth array having high durability on an outer surface, and an actuator using the same.

### Solution to Problem

According to a first aspect of the present invention, a hollow track body has a plurality of rolling body traveling sections formed in an outer surface of a hollow shaft in an axial direction and is supported by a support body via a plurality of rolling bodies that are rollable along the plurality of rolling body traveling sections, wherein at least one rack teeth array in which roots of teeth penetrate into a hollow section of the hollow shaft are formed at arc-shaped sections formed between the plurality of rolling body traveling sections in the axial direction.

According to a second aspect of the present invention, in the hollow track body according to the first aspect, a plurality of the rack teeth arrays are provided, and the rack teeth arrays are point-symmetrically formed with respect to a central axis of the hollow shaft.

According to a third aspect of the present invention, in the hollow track body according to the first or second aspect, the plurality of rolling body traveling sections have a pair of rolling body traveling surfaces on which the rolling bodies are disposed in back-to-back configuration.

According to a fourth aspect of the present invention, an actuator includes a track body in which a rack teeth array is disposed at an outer surface thereof in an axial direction; a support body configured to support the track body via a plurality of rolling bodies; a pinion gear meshed with the rack teeth array; and a rotary motor disposed at the support body to rotatably drive the pinion gear, wherein the hollow track body according to any one of claims 1 to 3 is used as the track body.

According to a fifth aspect of the present invention, a hollow track body has a plurality of rolling body traveling sections formed in an outer surface of a hollow shaft in an axial direction and is supported by a support body via a plurality of rolling bodies that are rollable along the plurality of rolling body traveling sections, wherein the plurality of rolling body traveling sections are formed by pressing the outer surface only.

### Advantageous Effects of Invention

The above-mentioned hollow track body and actuator can be realized as the hollow track body capable of forming the rack teeth array having high durability on the outer surface, and an actuator using the same.

### BRIEF DESCRIPTION OF DRAWINGS

FIG. 1 is a perspective view showing a main part of a rod-type actuator of a first embodiment of the present invention.

FIG. 2A is a front view showing the main part of the rod-type actuator of the first embodiment of the present invention.

FIG. 2B is a side view showing the main part of the rod-type actuator of the first embodiment of the present invention.

FIG. 2C is a cross-sectional view taken along line c-c, showing the main part of the rod-type actuator of the first embodiment of the present invention.

FIG. 3A is a front view showing a hollow rod.

FIG. 3B is a plan view showing the hollow rod.

FIG. 3C is a side view showing the hollow rod.

FIG. 3D is a cross-sectional view taken along line d-d, showing the hollow rod.

FIG. 4A is a view showing a manufacturing process of a hollow rod.

FIG. 4B is a view showing the manufacturing process of the hollow rod.

FIG. 4C is a view showing the manufacturing process of the hollow rod.

FIG. 4D is a view showing the manufacturing process of the hollow rod.

FIG. 5 is a perspective view showing a rod-type actuator of a second embodiment of the present invention.

### DESCRIPTION OF EMBODIMENTS

### First Embodiment

A rod-type actuator 1 and a hollow rod 21 according to an embodiment of the present invention will be described with reference to the accompanying drawings.

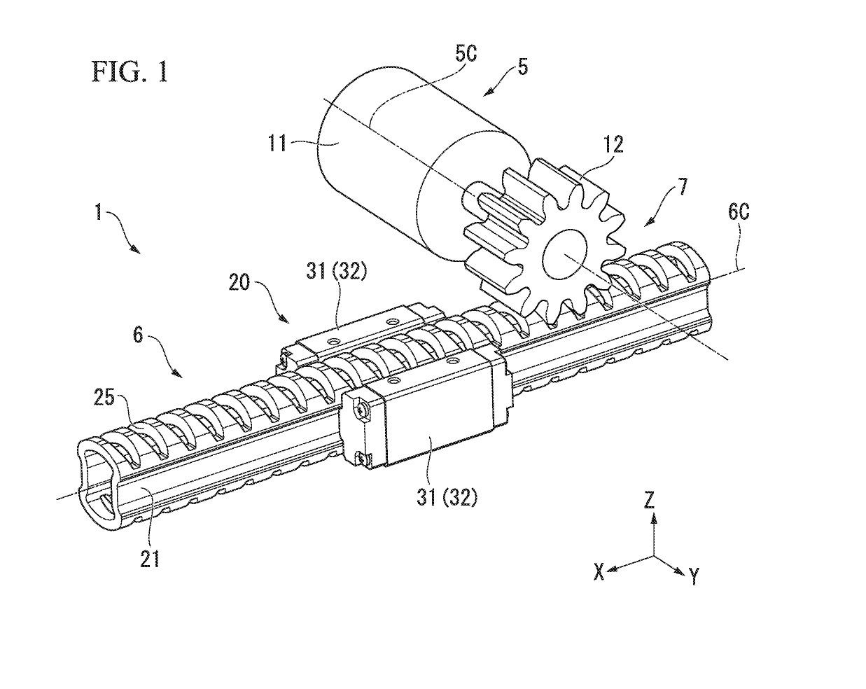

FIG. 1 is a perspective view showing a main part of the rod-type actuator 1 according to the first embodiment of the present invention.

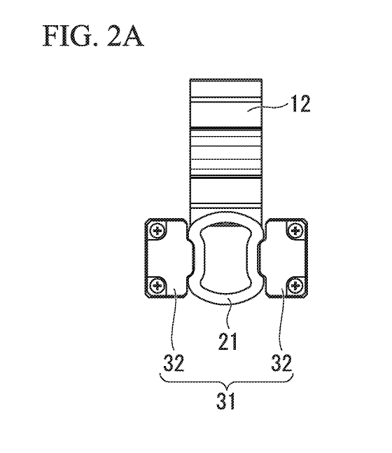

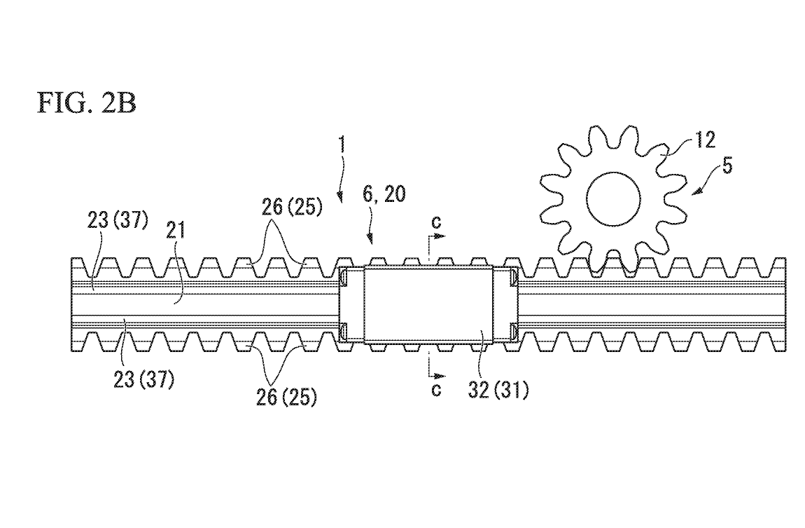

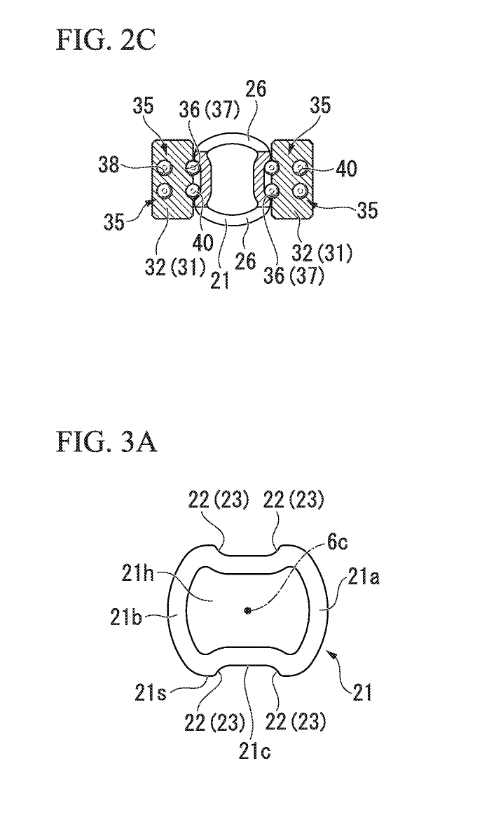

FIGS. 2A, 2B and 2C are a front view, a side view and a cross-sectional view taken along line c-c, respectively, showing the main part of the rod-type actuator 1.

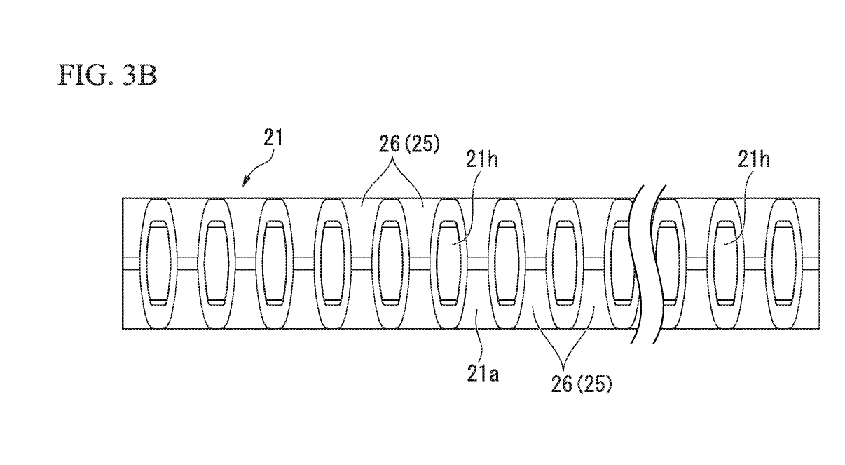

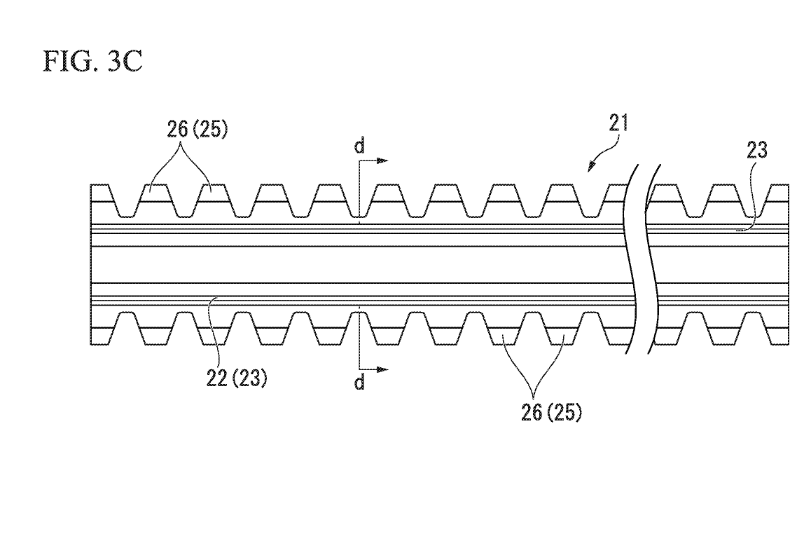

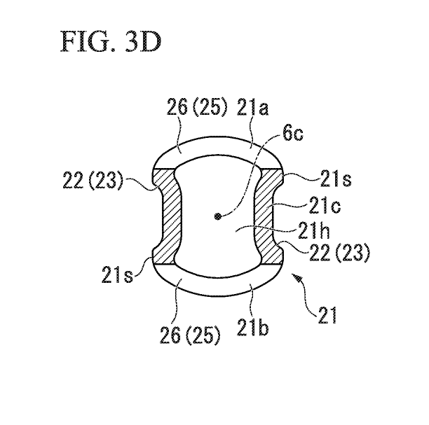

FIGS. 3A, 3B, 3C and 3D are a front view, a plan view, side view and a cross-sectional view taken along line d-d, respectively, showing the hollow rod 21.

The rod-type actuator (the actuator) 1 includes a motor unit 5 configured to generate a rotating force, and a main body section 6 driven by the motor unit 5 to perform linear movement.

As the motor unit 5 and the main body section 6 are connected to each other, a rack/pinion mechanism 7 is provided (a pinion gear 12 and a rack teeth array 25 are meshed).

A longitudinal direction of the main body section 6 is referred to as an X direction, a longitudinal direction of the motor unit 5 is referred to as a Y direction, and a direction perpendicular to the X direction and the Y direction (a thickness direction of the rod-type actuator 1) is referred to as a Z direction. In the Z direction, the main body section 6 side is referred to as a −Z direction and the motor unit 5 side is referred to as a +Z direction.

Central axes 5C and 6C of the motor unit 5 and the main body section 6 are disposed to cross (be perpendicular to) each other by 90°. The central axes 5C and 6C of the motor unit 5 and the main body section 6 are disposed not to intersect each other. That is, the central axes 5C and 6C of the motor unit 5 and the main body section 6 have a relation of positions of torsion. The main body section 6 and the motor unit 5 are connected via a connecting member (not shown).

The motor unit 5 includes a rotary motor 11, the pinion gear 12 attached to an output shaft of the rotary motor 11, and so on.

The rotary motor 11, which is a DC motor, is driven by an instruction from a control unit (not shown).

The main body section 6 includes a linear movement mechanism unit 20 configured to perform linear movement, the rack teeth array 25 configured to transmit a driving force, and so on.

The linear movement mechanism unit 20 is disposed at the −Z direction side of the motor unit 5. The linear movement mechanism unit 20, which is a guide type, includes the hollow rod 21, support blocks 31, balls 40, and so on.

The rack teeth array 25 is formed at the hollow rod 21 of the linear movement mechanism unit 20. The rack teeth array 25 is meshed with the pinion gear 12 of the motor unit 5 to transmit a driving force of the rotary motor 11 to the linear movement mechanism unit 20 (the hollow rod 21).

The hollow rod (the hollow track body) 21 is an elongated cylindrical steel member extending in the X direction. The hollow rod 21 has a hollow section 21h extending along the central axis 6C.

A cross section of the hollow rod 21 perpendicular to the X direction has a shape in which both end sections (an upper portion 21a and a lower portion 21b) in the Z direction are expanded in an arc shape and centers (central portions 21c) in the Z direction are recessed toward the hollow section 21h.

Rolling body traveling sections 22 are formed at the two central portions 21c in an outer surface 21s of the hollow rod 21. The rolling body traveling sections 22 are sections supported by the support blocks 31 via the balls 40.

Two ball rolling grooves (rolling body traveling surfaces) 23 on which the balls 40 roll are formed at the rolling body traveling sections 22 in parallel in the X direction. The two ball rolling grooves 23 are symmetrically disposed at the −Z direction side and the +Z direction side with the central axis 6C interposed therebetween.

The two ball rolling grooves 23 are formed to be inclined in mutually facing directions. For this reason, the balls 40 that roll on the two ball rolling grooves 23 are disposed in a so-called back-to-back configuration.

Four ball rolling grooves 23 are formed at the outer surface 21s of the hollow rod 21. The four ball rolling grooves 23 are point-symmetrically formed with respect to the central axis 6C.

Two rack teeth arrays 25 are formed at the hollow rod 21 in the X direction. The rack teeth arrays 25 are formed at the upper portion (an arc-shaped section) 21a and the lower portion (an arc-shaped section) 21b. In other words, the rack teeth array 25 are formed between areas expanded in arc shapes of the hollow rod 21, i.e., between the two rolling body traveling sections 22 (the central portions 21c).

Roots of teeth of rack teeth 26 that constitute the rack teeth arrays 25 penetrate into the hollow section 21h of the hollow rod 21. The rack teeth 26 are formed at the upper portion 21a and the lower portion 21b that expand in arc shapes.

For this reason, as shown in FIG. 3D, the roots of teeth penetrate into the hollow section 21h of the hollow rod 21 at a center in the tooth width direction (the Y direction). That is, the roots of teeth of the rack teeth 26 are not present in the center of the tooth width direction. In other words, the rack teeth 26 have the roots of teeth at both ends only in the tooth width direction (the Y direction).

Meanwhile, as shown in FIG. 3D, teeth tips of the rack teeth 26 are not present at both ends in the tooth width direction. The rack teeth 26 have teeth tips at a center only in the tooth width direction (the Y direction).

That is, the hollow rod 21 has the rack teeth array 25 constituted by the plurality of rack teeth 26 formed in arc shapes.

In this way, the roots of teeth at the center in the tooth width direction of the rack teeth 26 penetrate into the hollow section 21h of the hollow rod 21. Then, the roots of teeth at both ends in the tooth width direction of the rack teeth 26 are in the vicinity of the two rolling body traveling sections 22. That is, the rack teeth 26 are teeth having a maximum size that can be formed between the two rolling body traveling sections 22.

When the roots of teeth do not penetrate into the hollow section 21h, sizes of teeth of the rack teeth array should be reduced (for example, a module is 1.0 or less).

On the other hand, since the roots of teeth of the rack teeth array 25 penetrate into the hollow section 21h, the sizes of the teeth of the rack teeth 26 can be largely set (for example, a module is 2.5 or more). For this reason, the strength of the rack teeth array 25 (the rack teeth 26) is increased and durability is improved. In addition, since the rack teeth 26 that are large teeth are formed, it can contribute to the reduction in weight of the hollow rod 21.

The support block (the support body) 31 is a split type support block, and includes two blocks 32 having the same shape. The blocks 32 are disposed to be opposite to each other with a slight gap with respect to the rolling body traveling sections 22 of the hollow rod 21. The two blocks 32 are connected to each other via a connecting member (not shown).

The support block 31 holds the plurality of balls 40. Four endless circulation paths 35 having an endless elliptical or oval shape are formed in the support block 31. The plurality of balls 40 are held to be rollable in the four endless circulation paths 35.

A ball rolling groove 36 is formed in an inner surface of the support block 31 (the block 32) in the X direction. Two ball rolling grooves 36 are formed in inner surfaces of the blocks 32. For this reason, four ball rolling grooves 36 are formed at the support blocks 31.

The four ball rolling grooves 23 of the hollow rod 21 and the four ball rolling grooves 36 of the support blocks 31 are disposed to oppose each other. A space (a space extending in the X direction) formed between the ball rolling grooves 23 and the ball rolling grooves 36 becomes a load ball rolling path 37. For this reason, four load ball rolling paths 37 are formed between the hollow rod 21 and the support blocks 31.

Four no-load ball rolling paths 38 and four ball direction conversion paths (not shown) are formed in the support block 31. The two no-load ball rolling paths 38 and the two ball direction conversion paths are formed in the blocks 32.

The no-load ball rolling paths 38 are formed in the support blocks 31 (the blocks 32) in parallel to the ball rolling grooves 36 (the load ball rolling paths 37). Ball direction conversion paths connect the ball rolling grooves 36 (the load ball rolling paths 37) and the ball direction conversion paths at both ends in the Y direction of the support blocks 31 (the blocks 32).

The balls (the rolling bodies) 40 are spherical members formed of, for example, a metal material. The plurality of balls 40 are interposed between the hollow rod 21 and the support blocks 31 (the blocks 32) to facilitate the movement of the hollow rod 21 with respect to the support blocks 31.

The plurality of balls 40 are arranged in the endless circulation path 35 substantially without a gap to circulate through the endless circulation path 35. The hollow rod 21 is supported to be reciprocally movable with respect to the support block 31 via the plurality of balls 40.

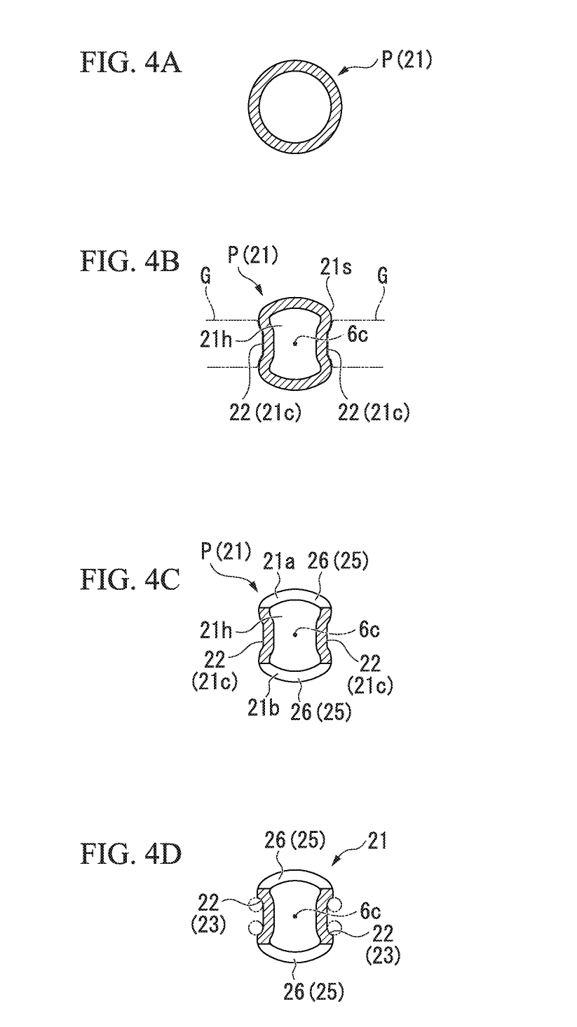

FIGS. 4A, 4B, 4C and 4D are views showing a manufacturing process of the hollow rod 21. The manufacturing process of the hollow rod 21 will be described in sequence of processes.

The manufacturing process of the hollow rod 21 has a rolling body traveling section forming process A, a rack teeth forming process B, a heat treatment process C and a ball rolling groove forming process D.

First, a cylindrical shaft body P serving as an element is prepared (see FIG. 4A). The cylindrical shaft body P may be a prefabricated pipe member. In addition, the cylindrical shaft body P may be formed through drawing or extrusion. The cylindrical shaft body P is formed of, for example, carbon steel (S55C or the like).

### Rolling Body Traveling Section Forming Process A

First, the two rolling body traveling sections 22 are formed in the cylindrical shaft body P. A jig G presses only the outer surface (the outer surface 21s) of the cylindrical shaft body P to dent a portion of the outer surface. Specifically, a portion of the outer surface of the cylindrical shaft body P is pressed and dented by pressing or roll forming (see FIG. 4B). While the rolling body traveling section 22 can be formed by drawing, since the manufacturing cost is increased, pressing or roll forming is particularly preferable.

The rolling body traveling section forming process A is performed in a state in which a jig is not inserted into the hollow section (the hollow section 21h) of the cylindrical shaft body P. In this way, in the rolling body traveling section forming process A of the embodiment, since drawing or the like using a die and a plug is not performed, the two rolling body traveling sections 22 can be easily formed. Accordingly, the manufacturing costs can be reduced.

### Rack Teeth Forming Process B

Next, the rack teeth array 25 is formed at the cylindrical shaft body P. In the cylindrical shaft body P, the rack teeth 26 are formed at a section between the two rolling body traveling sections 22 (the upper portion 21a and the lower portion 21b) (see FIG. 4C). Formation of the rack teeth 26 is performed by known gear cutting.

### Heat Treatment Process C

Further, heat treatment is performed on the cylindrical shaft body P. Carburizing and quenching, high frequency quenching, tempering, or the like, is performed. Any heat treatment can be performed according to the material of the cylindrical shaft body P or the use of the hollow rod 21.

Since the cylindrical shaft body P (the hollow rod 21) has a point-symmetrical shape with respect to the central axis 6C, uniform quenching becomes possible. For this reason, the strength or durability of the rack teeth array 25 (the rack teeth 26) is increased.

### Ball Rolling Groove Forming Process D

Finally, the two ball rolling grooves 23 are formed in the rolling body traveling section 22. The ball rolling grooves 23 are formed by grinding (FIG. 4D).

In addition to the ball rolling groove forming process D, grinding of the rack teeth 26 may be performed.

The hollow rod 21 is manufactured through the above-mentioned processes.

According to the method of manufacturing the hollow rod 21, since drawing or the like using a die and a plug is not performed, the rolling body traveling section 22 (the ball rolling groove 23) can be easily formed. Accordingly, an increase in manufacturing cost can be limited. The two ball rolling grooves 23 in which the balls 40 are provided in back-to-back configuration can be easily obtained only by grinding the portion (the rolling body traveling section 22) obtained by pressing and denting a portion of the outer surface of the cylindrical shaft body P.

An operation of the rod-type actuator 1 will be described.

When the rod-type actuator 1 is operated, the rotary motor 11 of the motor unit 5 is driven by an instruction from a control unit (not shown). When the pinion gear 12 attached to the rotary motor 11 is rotated around the central axis 5C, a driving force is transmitted to the rack teeth array 25 meshed with the pinion gear 12.

The rack/pinion mechanism 7 constituted by the pinion gear 12 and the rack teeth array 25 converts rotational movement into linear movement. That is, when the pinion gear 12 is rotated around the central axis 6C, the hollow rod 21 in which the rack teeth array 25 is formed moves in the X direction.

In this way, as the rotary motor 11 is driven, the hollow rod 21 can be moved in the X direction. That is, the linear movement mechanism unit 20 can be expanded and contracted.

Accordingly, a member or the like connected to an end portion of the hollow rod 21 of the rod-type actuator 1 can be moved in the X direction or a pressing force or a tensile force can be applied to the member abutting the end portion of the hollow rod 21.

For example, when the rod-type actuator 1 is applied to a parking gate, a crossing gate may be connected to the end portion of the hollow rod 21 to be swung.

For example, when the rod-type actuator 1 is applied to a chip mounter, a suction nozzle may be attached to the end portion of the hollow rod 21 to suction and hold an electronic part or the like.

The roots of teeth of the rack teeth array 25 (the rack teeth 26) of the rod-type actuator 1 penetrate into the hollow section 21h of the hollow rod 21. For this reason, the teeth (the rack teeth 26) having a maximum size can be formed between the two rolling body traveling sections 22. Accordingly, in comparison with the related art, since the size of the teeth can be largely set, strength of the rack teeth array 25 (the rack teeth 26) is increased and durability is improved. In addition, since the rack teeth 26 are formed as large teeth, the weight of the hollow rod 21 can be further reduced.

### Second Embodiment

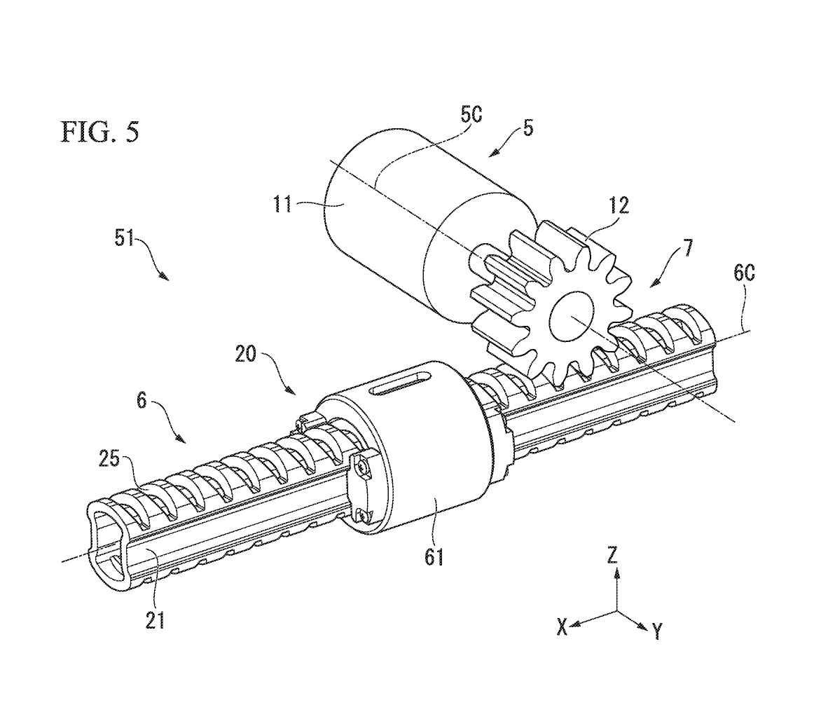

FIG. 5 is an external perspective view showing a rod-type actuator 51 according to a second embodiment of the present invention. The same members as the rod-type actuator 1 according to the first embodiment are designated by the same reference numerals and a description thereof will be omitted.

The rod-type actuator (the actuator) 51 includes a motor unit 5, a main body section 6, and so on. The main body section 6 includes a linear movement mechanism unit 20, a rack teeth array 25, and so on.

The linear movement mechanism unit 20 of the main body section 6 is a spline type and includes a hollow rod 21, a support block 61, balls 40, and so on.

Unlike the support block 31, the support block (the support body) 61 is disposed to cover the entire circumference of the outer surface of the hollow rod 21.

Like the support block 31, four endless circulation paths 35 that form an endless elliptical or oval shape are formed in the support block 61. The plurality of balls 40 are rollably held in the four endless circulation paths 35.

The four ball rolling grooves 36 extending in the X direction are formed in the inner surface of the support block 61. The four ball rolling grooves 23 of the hollow rod 21 and the four ball rolling grooves 36 of the support block 61 are disposed so as to oppose each other.

In this way, like the rod-type actuator 1, the rod-type actuator 51 exhibits the same effect as the rod-type actuator 1 because the hollow rod 21 is provided.

Shapes, combinations, or the like, of the components shown in the above-mentioned embodiments are exemplarily provided and various modifications may be made based on design requirements without departing from the spirit of the present invention.

The rolling body is not limited to the ball 40 but may be a roller.

While the case in which the rack teeth arrays 25 are formed at the upper portion 21a and the lower portion 21b of the hollow rod 21 has been described, the present invention is not limited thereto. The rack teeth array 25 may be formed at only one of the upper portion 21a and the lower portion 21b.

The rack teeth array 25 formed at the upper portion 21a and the rack teeth array 25 formed at the lower portion 21b are not limited to the same shape. The two rack teeth arrays 25 may have different shape (modules).

### INDUSTRIAL APPLICABILITY

The above-mentioned hollow track body and actuator can be realized as the hollow track body capable of forming the rack teeth array having high durability on the outer surface, and an actuator using the same.

### REFERENCE SIGNS LIST

1 Rod-type actuator (actuator)
11 Rotary motor
12 Pinion gear
21 Hollow rod (hollow track body)
21a Upper portion (arc-shaped section)
21b Lower portion (arc-shaped section)
21h Hollow section
21s Outer surface
22 Rolling body traveling section
23 Ball rolling groove (rolling body traveling surface)
25 Rack teeth array
26 Rack teeth
31 Support block (support body)
40 Ball (rolling body)
51 Rod-type actuator (actuator)
61 Support block (support body)

1. A hollow track body having a plurality of rolling body traveling sections formed in an outer surface of a hollow shaft in an axial direction and being supported by a support body via a plurality of rolling bodies that are rollable along the plurality of rolling body traveling sections,
wherein a rack teeth array in which roots of teeth penetrate into a hollow section of the hollow shaft are formed at arc-shaped sections formed between the plurality of rolling body traveling sections in the axial direction.

2. The hollow track body according to claim 1, wherein a plurality of the rack teeth arrays are provided, and
the rack teeth arrays are point-symmetrically formed with respect to a central axis of the hollow shaft.

3. The hollow track body according to claim 1, wherein the plurality of rolling body traveling sections have a pair of rolling body traveling surfaces on which the rolling bodies are disposed in back-to-back configuration.

4. An actuator comprising:
a track body in which a rack teeth array is disposed at an outer surface thereof in an axial direction;
a support body configured to support the track body via a plurality of rolling bodies;
a pinion gear meshed with the rack teeth array; and
a rotary motor disposed at the support. body to rotatably drive the pinion gear,
wherein the hollow track body according to claim 1 is used as the track body.

5. A hollow track body having a plurality of rolling body traveling sections formed in an outer surface of a hollow shaft in an axial direction and being supported by a support body via a plurality of rolling bodies that are rollable along the plurality of rolling body traveling sections,
wherein the plurality of rolling body traveling sections are formed by pressing the outer surface only

6. The hollow track body according to claim 2, wherein the plurality of rolling body traveling sections have a pair of rolling body traveling surfaces on which the rolling bodies are disposed in back-to-back configuration.
